(19) United States
(12) Patent Application Publication
(10) Pub. No.: US 2023/0275203 A1
(43) Pub. Date: Aug. 31, 2023

(54) ALL-SOLID-STATE BATTERY HAVING PROTECTIVE LAYER COMPRISING METAL SULFIDE AND METHOD FOR MANUFACTURING THE SAME

(71) Applicants: Hyundai Motor Company, Seoul (KR); Kia Corporation, Seoul (KR)

(72) Inventors: Ga Hyeon Im, Hwaseong (KR); Seung Ho Choi, Hanam (KR); Sang Heon Lee, Yongin (KR); Yun Sung Kim, Seoul (KR)

(21) Appl. No.: 18/078,773

(22) Filed: Dec. 9, 2022

(30) Foreign Application Priority Data
Feb. 25, 2022 (KR) 10-2022-0024791

(51) Int. Cl. H01M 4/04; H01M 4/62

(52) U.S. Cl. CPC H01M 4/0404; H01M 4/625; H01M 4/0407; H01M 2004/021

(57) ABSTRACT

Disclosed are an all-solid-state battery having a protective layer including a composite including a metal sulfide and a carbon component, and a method for manufacturing the same. The all-solid-state battery includes an anode current collector, the protective layer disposed on the anode current collector, a solid electrolyte layer disposed on the protective layer, a cathode active material layer disposed on the solid electrolyte layer, and a cathode current collector disposed on the cathode active material layer, and the protective layer includes a matrix comprising the composite including the metal sulfide and the carbon component, and a metal component distributed in the matrix and capable of alloying with lithium.

### CROSS-REFERENCE TO RELATED APPLICATION

This application claims under 35 U.S.C. § 119(a) the benefit of priority to Korean Patent Application No. 10-2022-0024791 filed on Feb. 25, 2022, the entire contents of which are incorporated herein by reference.

### TECHNICAL FIELD

The present invention relates to an all-solid-state battery having a protective layer including a composite including a metal sulfide and a carbon component and a method for manufacturing the same.

### BACKGROUND

Electrochemical metal deposition is technology in which a metal material from metal ions is deposited onto the surface of a substrate to a desired thickness. Most metal deposition technologies use media, such as a liquid electrolyte, and a metal may be produced through an electrochemical reduction reaction from a liquid in which metal ions are dissolved. Metals, such as Al, Mg, Ni, Zn, etc. may be produced thereby. When electrochemical metal deposition is applied to an all-solid-state battery, an anodeless all-solid-state battery including no anode active material may be designed. When the anodeless all-solid-state battery is charged, lithium ions migrate to the surface of an anode current collector through a solid electrolyte, and the lithium ions are reduced and are thus stored as lithium metal. Simultaneously, the amount of lithium deposited may be precisely adjusted by controlling a current density and a charging time. Consequently, an anode active material included in the all-solid-state battery may be omitted through the electromechanical metal reduction reaction, and thus, an energy density per volume may be increased, and the manufacturing costs of cells may be reduced.

In order to reversibly perform charging and discharging of the anodeless all-solid-state battery, lithium metal should be uniformly precipitated on the surface of the anode current collector. For example, generation of pores between the solid electrolyte layer and the anode current collector are avoided. However, it may be difficult to form a uniform interface between the solid electrolyte layer and the anode current collector due to the irregular size of the solid electrolyte layer and the hardness of the anode current collector.

Therefore, a functional material configured to fill pores between the solid electrolyte layer and the anode current collector is required. The functional material added to the anode current collector requires characteristics, such as a low reversible capacity, electrical conductivity, a proper particle size to fill the pores, etc.

The above information disclosed in this Background section is only for enhancement of understanding of the background of the invention and therefore it may contain information that does not form the prior art that is already known in this country to a person of ordinary skill in the art.

### SUMMARY

In preferred aspects, provided is an all-solid-state battery having a protective layer configured to induce uniform precipitation and storage of lithium ions, and a method for manufacturing the same.

In one aspect, the present invention provides an all-solid-state battery including an anode current collector, a protective layer disposed on the anode current collector, a solid electrolyte layer disposed on the protective layer, a cathode active material layer disposed on the solid electrolyte layer, and a cathode current collector disposed on the cathode active material layer. In particular, the protective layer includes a matrix including a composite including a metal sulfide and a carbon component, and a metal component distributed in the matrix and capable of alloying with lithium.

A term “all-solid state battery” as used herein refers to a rechargeable secondary battery that includes an electrolyte in a solid state for transferring ions between the electrodes of the battery.

The “carbon component” as used herein refers to elemental carbon material (e.g., graphite, coal, carbon nanotubes, fullerene or the like), which may be unmodified, modified with functional group or processed, or a compound (e.g., covalent compound, ionic compound, or salt) in including carbon constituting the dominant parts of weight of the compound.

The term “metal component” as used herein refers to an elemental metal, which may be unmodified, modified with functional group or processed, or a compound (e.g., covalent compound, ionic compound, or salt) including one or more metal elements in its molecular formula. Preferred metal components may exist in an ionic compound (e.g., metal halide, metal nitrate, metal carbonate) or salt form thereof, which can dissociate into cation and anion in a polar solvent (e.g., aqueous solution, alcohol or polar aprotic solvent).

The metal sulfide may include a compound expressed as MₓS_{y}, wherein M may include one or more selected from the group consisting of Mo, W, Cu, Co, Ti, Ni, and Fe, 1≤x≤3 and 0.5≤y≤4.

The carbon component may include spherical particles having a particle size D50 of about 10 nm to 100 nm, or linear particles having a cross-sectional diameter of about 10 nm to 300 nm.

The carbon component may include one or more selected from the group consisting of carbon black, carbon nanotubes, carbon fiber, and vapor-grown carbon fiber (VGCF).

In yet another preferred embodiment, a particle size D50 of the composite may be about 10 nm to 1 μm.

The composite may include the metal sulfide and the carbon component at a mass ratio of about 2:8 to 5:5.

The metal component may include one or more selected from the group consisting of Ag, Zn, Mg, Bi, and Sn.

A particle size D50 of the metal component may be about 30 nm to 500 nm.

The protective layer may include an amount of about 50% to 80% by weight of the matrix and an amount of about 20% to 50% by weight of the metal component, based on the total weight of the protective layer, and may have a thickness of about 1 μm to 20 μm.

The metal sulfide may react with lithium ions to produce lithium sulfide (Li₂S) and a metal during charging and discharging of the all-solid-state battery, and lithium may be stored between the anode current collector and the protective layer.

In another aspect, the present invention provides a method for manufacturing an all-solid-state battery. The method including preparing a composite including a metal sulfide and a carbon component by performing mechanical milling, preparing a slurry including the composite and a metal component capable of alloying with lithium, forming a protective layer by applying the slurry to a substrate, and preparing a stack including an anode current collector, the protective layer disposed on the anode current collector, a solid electrolyte layer disposed on the protective layer, a cathode active material layer disposed on the solid electrolyte layer, and a cathode current collector disposed on the cathode active material layer. In particular, the protective layer includes a matrix formed of the composite including the metal sulfide and the carbon component, and the metal component distributed in the matrix and capable of alloying with lithium.

Also provided is a vehicle include the all-solid-state battery as described herein.

Other aspects of the invention are discussed infra.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows a cross-sectional view of an exemplary all-solid-state battery according to an exemplary embodiment of the present invention;

FIG. 2 shows a cross-sectional view of the state in which an exemplary all-solid-state battery according to an exemplary embodiment of the present invention is charged;

FIG. 3 shows Scanning Electron Microscopy with Energy Dispersive X-ray Spectroscopy (SEM-EDS) analysis results of a composite of Example 1;

FIG. 4 shows SEM-EDS analysis results of a protective layer of Example 1;

FIG. 5 shows SEM analysis results of the cross-section of a half-cell employing the protective layer of Example 1, after initial deposition;

FIG. 6 shows initial charging and discharging results of the half-cell employing the protective layer of Example 1;

FIG. 7 shows initial charging and discharging results of a half-cell employing a protective layer of Comparative Example;

FIG. 8 shows charge and discharge cycle of the half-cell employing the protective layer of Example 1;

FIG. 9A shows charge and discharge cycle of a half-cell employing a protective layer of Example 2;

FIG. 9B shows initial charging and discharging of the half-cell employing the protective layer of Example 2;

FIG. 10 shows charge and discharge cycle of a half-cell employing a protective layer of Example 3; and

FIG. 11 shows charge and discharge cycle of a half-cell employing a protective layer of Example 4.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

The above-described objects, other objects, advantages and features of the present invention will become apparent from the descriptions of embodiments given herein below with reference to the accompanying drawings. However, the present invention is not limited to the embodiments disclosed herein and may be implemented in various different forms. The embodiments are provided to make the description of the present invention thorough and to fully convey the scope of the present invention to those skilled in the art.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus, it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

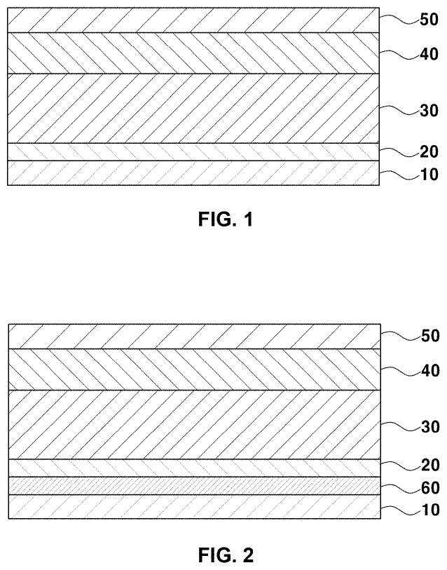

FIG. 1 shows a cross-sectional view of an exemplary all-solid-state battery according to an exemplary embodiment of the present invention. The all-solid-state battery may be configured such that an anode current collector 10, a protective layer 20, a solid electrolyte layer 30, a cathode active material layer 40 and a cathode current collector 50 are stacked.

FIG. 2 shows a cross-sectional view of the state in which an exemplary all-solid-state battery according to an exemplary embodiment of the present invention is charged. The all-solid-state battery may include a lithium metal layer 60 interposed between the anode current collector 10 and the protective layer 20.

The anode current collector 10 may be a plate-shaped base material having electrical conductivity. The anode current collector 10 may preferably have the shape of a sheet, a thin film, or a foil.

The anode current collector 10 may include a material which does not react with lithium. The anode current collector 10 may include one or more selected from the group consisting of Ni, Cu, stainless steel (SUS).

The protective layer 20 may induce lithium ions introduced from the cathode active material layer 40 to be uniformly precipitated and stored on the anode current collector 10.

The protective layer 20 may include a matrix formed of a composite including a metal sulfide and a carbon component, and a metal component distributed in the matrix.

The composite is not a simple mixture of the metal sulfide and the carbon component, and may be produced by performing mechanical milling of the metal sulfide and the carbon component. The particle size of the metal sulfide may be reduced to a nanoscopic scale through mechanical milling. The particle size D50 of the composite is determined by the particle size D50 of the carbon component which is a starting material. This will be described below. After the metal sulfide and the carbon component have been mixed, the composite in which the metal sulfide particles are very uniformly distributed onto the surface of the carbon component may be acquired. by comminuting the metal sulfide particles along the surface of the carbon component through mechanical milling

When the all-solid-state battery is charged or discharged, the metal sulfide may react with lithium ions to produce lithium sulfide (Li₂S) and metal ions. Charging or discharging of the all-solid-state battery may be a formation process. Consequently, when the all-solid-state battery is charged or discharged, the composite may exist in the forms of lithium sulfide (Li₂S), the metal and the carbon component. In the protective layer 20, lithium sulfide (Li₂S) and the metal may be involved in migration of the lithium ions, and the carbon component may serve as an electron migration path.

The metal sulfide may include the sulfide of a metal which does not form an alloy through reaction with lithium ions. The metal sulfide may include a compound expressed as MₓS_{y}, wherein M includes one or more selected from the group consisting of Mo, W, Cu, Co, Ti, Ni, and Fe, 1≤x≤3 and 0.5≤y≤4. Preferably, the metal sulfide may include MoS₂.

The carbon component may include one or more selected from the group consisting of carbon black, carbon nanotubes, carbon fiber, and vapor-grown carbon fiber (VGCF).

The particle size D50 of the composite may be about 10 nm to 1 μm. When the particle size D50 of the composite is within the above numerical range, the composite may fill pores between the solid electrolyte layer 30 and the anode current collector 10, and may thus form a uniform interface therebetween.

The composite may include the metal sulfide and the carbon component at a mass ratio of about 2:8 to 5:5. When the mass ratio of the metal sulfide to the carbon component is within the above numerical range, the migration paths of lithium ions and electrons in the protective layer 20 may be formed in balance. When the content of the metal sulfide is excessively high, initial irreversibility is increased, and thus, the capacity of the battery may be reduced and the electrical conductivity of the protective layer 20 may be reduced.

The metal component may include one or more selected from the group consisting of Ag, Zn, Mg, Bi, and Sn, which may form an alloy with lithium.

The particle size D50 of the metal component may be about 30 nm to 500 nm. When the particle size D50 of the metal component is within the above numerical range, the metal component may uniformly and easily react with lithium ions. Particularly, when the particle size D50 of the metal component is greater than about 500 nm, the metal component may not be suitable as a metal seed.

The protective layer 20 may include an amount of about 50% to 80% by weight of the matrix, and an amount of about 20% to 50% by weight of the metal component, based on the total weight of the protective layer. When the content of the metal component is greater than about 50% by weight, the lithium ion conductivity and the electron conductivity of the protective layer 20 are reduced, and thus, the lithium metal layer 60 may not be uniformly formed.

The protective layer 20 may further include a binder. The protective layer 20 may include about 1 part by weight to 5 parts by weight of the binder based on 100 parts by weight of the sum of the matrix and the metal component. When the content of the binder is greater than the above range, e.g., greater than about 5 parts by weight, the binder may disturb migration of lithium ions in the protective layer 20.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC) or the like.

The thickness of the protective layer 20 may be about 1 μm to 20 μm. When the thickness of the protective layer 20 is less than 1 μm, it is difficult to fill the pores between the solid electrolyte layer 30 and the anode current collector 10 and, when the thickness of the protective layer 20 exceeds 20 μm, energy density may be reduced.

The solid electrolyte layer 30 is interposed between the cathode active material layer 40 and the anode current collector 10, and may conduct lithium ions.

The solid electrolyte layer 30 may include a solid electrolyte having lithium ion conductivity.

The solid electrolyte may include at least one selected from the group consisting of oxide-based solid electrolytes, sulfide-based solid electrolytes, polymer solid electrolytes and combinations thereof. Preferably, sulfide-based solid electrolytes having high lithium ion conductivity may be used. The sulfide-based solid electrolytes may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S-B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), and Li₁₀GeP₂S₁₂, without being limited thereto.

The oxide-based solid electrolytes may include perovskite-type LLTO (Li₃ₓLa_{2/3-x}TiO₃), phosphate-based NASICON-type LATP(Li₁₊ₓAlₓTi₂₋ₓ(PO₄)₃), etc.

The polymer electrolytes may include gel polymer electrolytes, solid polymer electrolytes, etc.

The solid electrolyte layer 30 may further include a binder. The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC) or the like.

The cathode active material layer 40 may occlude and release lithium ions. The cathode active material layer 40 may include a cathode active material, a solid electrolyte, a conductive material, a binder, etc.

The cathode active material may be an oxide active material or a sulfide active material.

The oxide active material may be an oxide active material or a sulfide active material.

The oxide active material may be a rock salt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), or lithium titanate, such as Li₄Ti₅O₁₂.

The sulfide active material may include copper Chevrel, iron sulfide, cobalt sulfide, nickel sulfide or the like.

The solid electrolyte may include at least one selected from the group consisting of oxide-based solid electrolytes, sulfide-based solid electrolytes, polymer electrolytes and combinations thereof. Preferably, sulfide-based solid electrolytes having high lithium ion conductivity may be used. The sulfide-based solid electrolytes may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), and Li₁₀ GeP₂S₁₂, without being limited thereto.

The oxide-based solid electrolytes may include perovskite-type LLTO (Li₃ₓLa_{2/3-x}TiO₃), phosphate-based NASICON-type LATP(Li₁₊ₓAlₓTi₂₋ₓ(PO₄)₃), etc.

The polymer electrolytes may include gel polymer electrolytes, solid polymer electrolytes, etc.

The conductive material may be carbon black, conductive graphite, ethylene black, carbon fiber, graphene or the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC) or the like.

The cathode current collector 50 may be a plate-shaped base material having electrical conductivity. Concretely, the cathode current collector 50 may have the shape of a sheet or a thin film.

The cathode current collector 50 may include at least one selected from the group consisting of indium, copper, magnesium, aluminum, stainless steel, iron and combinations thereof.

The method for manufacturing an all-solid-state battery may include preparing a composite including a metal sulfide and a carbon component by performing mechanical milling, preparing a slurry including the composite and a metal component capable of alloying with lithium, forming a protective layer by applying the slurry to a substrate, and preparing a stack including an anode current collector, the protective layer disposed on the anode current collector, a solid electrolyte layer disposed on the protective layer, a cathode active material layer disposed on the solid electrolyte layer, and a cathode current collector disposed on the cathode active material layer.

Mechanical milling of the metal sulfide and the carbon component are not limited to specific conditions, and may be performed under appropriate conditions including a rotating speed and a time set to form the above-described particle size D50 of the composite.

The mechanical milling is not limited to a specific method, and may be performed through methods, such as ball milling, air-jet milling, bead milling, roll milling, planetary milling, hand milling, high energy ball milling, planetary ball milling, stirred ball milling, vibration milling, mechanofusion milling, shaker milling, attritor milling, disk milling, shape milling, Nauta milling, Nobilta milling, high speed mixing, etc.

The particle size D50 of the metal sulfide which is a starting material may be about 10 nm to 50 μm. Metal sulfide particles may be ground along the surface of the carbon component through mechanical milling, and thus the metal sulfide particles having not only nano sizes, but also bulk sizes may be used.

The carbon component may include spherical particles having a particle size D50 of about 10 nm to 100 nm, or linear particles configured such that the cross-section thereof has a diameter of about 10 nm to 300 nm. Since the particle size D50 of the composite is determined by the particle size D50 of the carbon component, a carbon component having a proper particle size D50 may be selected and used depending on a desired particle size D50 of the composite.

The slurry may be obtained by adding the prepared composite and the metal component into a solvent or the like. Moreover, a binder may further be added.

The solvent is not limited to a specific solvent, and may include any solvent which is generally used in the field to which the present invention pertains. For example, the solvent may include n-methyl-2-pyrrolidone (NMP), water, ethanol, isopropanol or the like.

The protective layer may be formed by applying the slurry to the substrate. The substrate may be an anode current collector. However, formation of the protective layer is not limited thereto, and the protective layer may be formed on a releasing film, and then, the protective layer on the substrate may be transferred onto the anode current collector.

Preparation of the stack is not limited to a specific method. The respective elements of the stack may be formed at the same time or at different times. Further, the above-described method for manufacturing the all-solid-state battery may be executed by forming the solid electrolyte layer directly on the protective layer, forming the cathode active material layer directly on the solid electrolyte layer, and forming the cathode current collector directly on the cathode active material, as described above, or may be executed by separately preparing the respective elements and then stacking the respective elements into the structure shown in FIG. 1.

### EXAMPLE

Hereinafter, the present invention will be described in more detail through the following examples. The following examples serve merely to exemplarily describe the present invention, and are not intended to limit the scope of the invention.

### Example 1

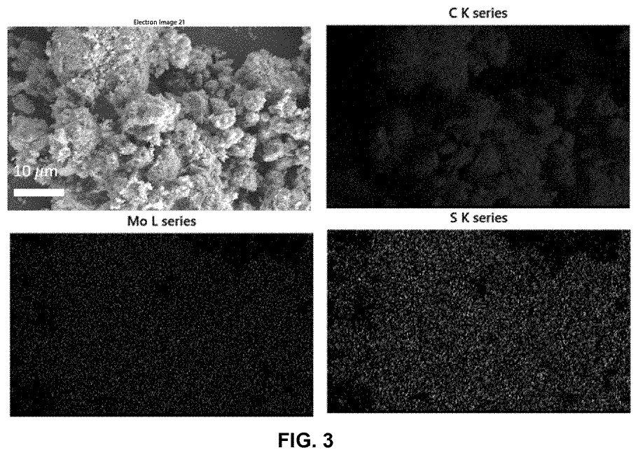

A composite was obtained by mixing MoS₂ as a metal sulfide and carbon black as a carbon component and then performing mechanical milling of the obtained mixture. Here, the mass ratio of the metal sulfide to the carbon component was 3:7. FIG. 3 shows Scanning Electron Microscopy with Energy Dispersive X-ray Spectroscopy (SEM-EDS) analysis results of the composite. As shown in FIG. 3, Mo, S and C particles are uniformly distributed in the composite.

A slurry was obtained by adding the composite, Ag as a metal component, and polyvinylidene fluoride (PVDF) as a binder into a solvent. 70% by weight of the composite and 30% by weight of the metal component were used, and about 5 parts by weight of the binder was used based on 100 parts by weight of the sum of the composite and the metal component. N-methyl-2-pyrrolidone (NMP) was used as the solvent.

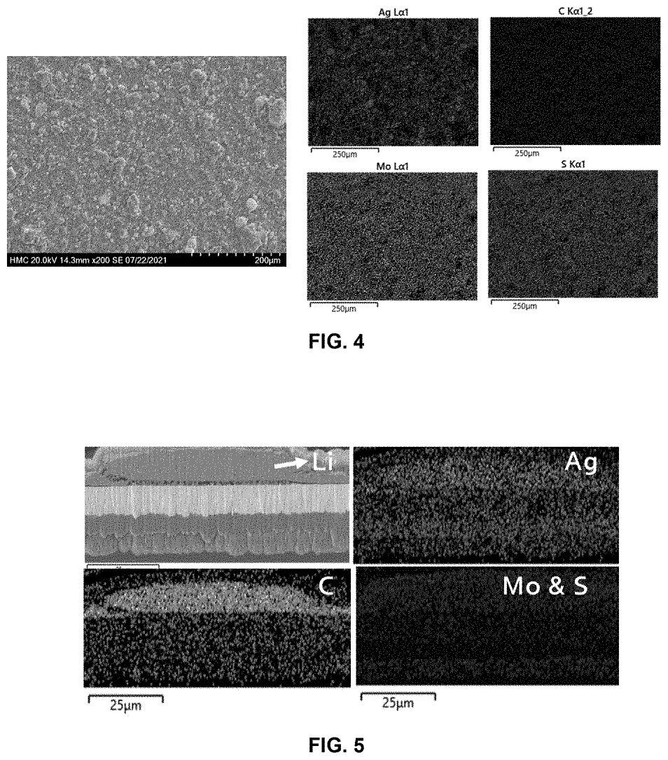

A protective layer was formed by applying the slurry to an anode current collector and then drying the slurry. FIG. 4 shows SEM-EDS analysis results of the protective layer. As shown in FIG. 4, Ag particles serving as the metal component were uniformly distributed in a matrix formed of the composite.

### Comparative Example

A protective layer was formed in the same manner as in Example 1 except that a composite was not prepared, and 70% by weight of carbon black and 30% by weight of a metal component were mixed to form the protective layer.

FIG. 5 shows SEM analysis results of the cross-section of a half-cell employing the protective layer of Example 1, after initial deposition. Here, a current density was 1.17 mA/cm², a deposition capacity was 3.525 mAh/cm², and an evaluation temperature was 30° C. As shown in FIG. 5, the lithium was uniformly deposited on the anode current collector. Uniform lithium deposition was induced through alloy reaction with Ag having affinity for lithium. Further, the composite including MoS₂ and the carbon component served as a delivery path of lithium ions, and thus effectively migrate lithium ions both at low and high temperatures.

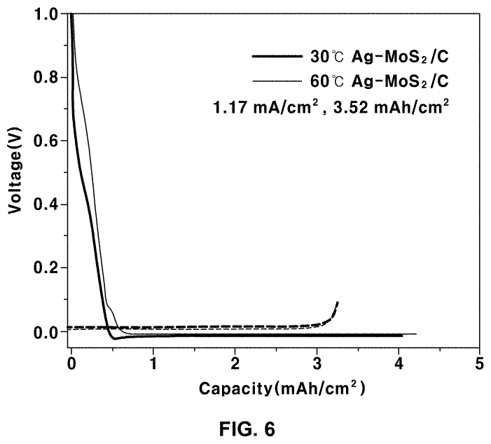

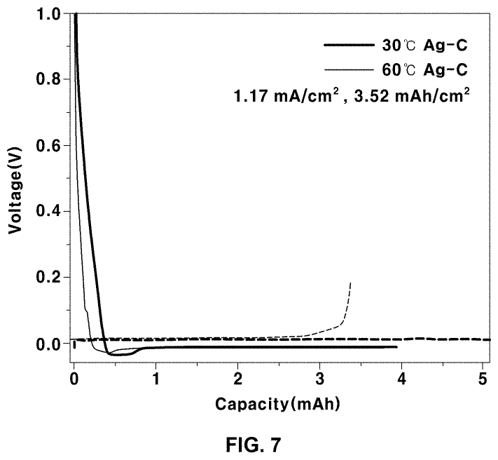

FIG. 6 shows initial charging and discharging results of the half-cell employing the protective layer of Example 1. FIG. 7 shows initial charging and discharging results of a half-cell employing the protective layer of Comparative Example. As shown in FIG. 6, when MoS₂ was employed as the metal sulfide, the half-cell exhibited a capacity of 0.5 mAh at 0.6 V during the discharging process both at room temperature and at a high temperature. In other words, the reaction MoS₂+Li⁺→Li₂S happened at a voltage of about 0.6 V and thus lithium ions in the protective layer are able to migrate. As shown in FIG. 7, the half-cell exhibits non-ideal behavior in which the amount of desorbed lithium ions was greater than the amount of deposited lithium ions during driving at room temperature, and this state indicates that short circuit of the half-cell occurred. The half-cell of Example 1 was more stable than the half-cell of Comparative Example during charging and discharging, because the initial conversion reaction of the metal sulfide improved lithium ion conductivity of the half-cell at room temperature.

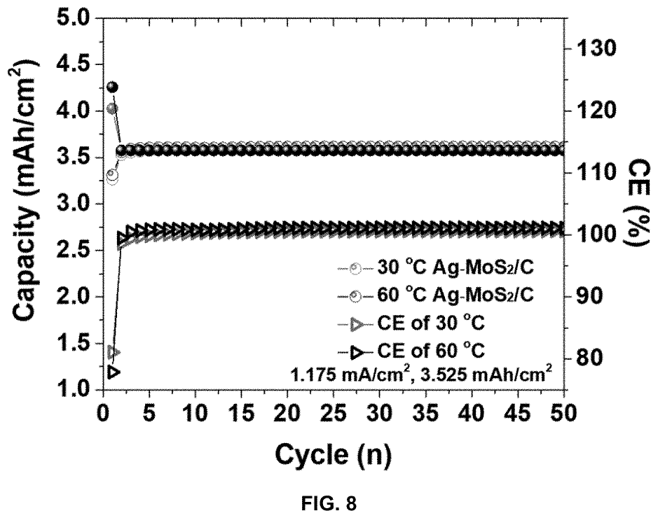

FIG. 8 shows charge and discharge cycle of the half-cell employing the protective layer of Example 1. A current density was 1.17 mA/cm², and a deposition capacity was 3.525 mAh/cm₂. The half-cell exhibits an average Coulombic efficiency which is close to 100% at from room temperature (30° C.) to a high temperature (60° C.) until the half-cell reaches 50 charge and discharge cycles, and exhibits stable characteristics and efficiency. This proves that Ag in the protective layer induces effective lithium deposition, and the composite provides lithium ion diffusion paths and thus induces smooth lithium ion migration.

### Example 2

A protective layer was formed in the same manner as in Example 1 except that the mass ratio of a metal sulfide to a carbon component in a composite was adjusted to 2:8.

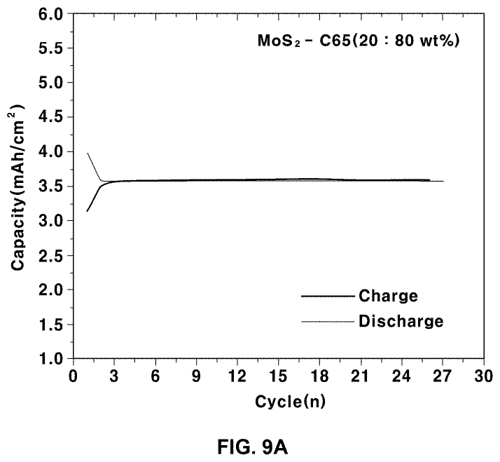

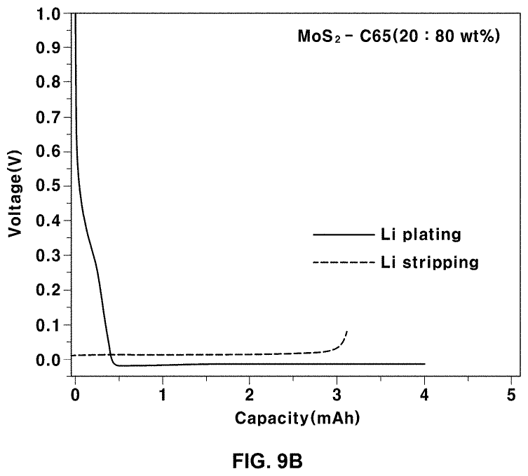

FIG. 9A shows charge and discharge cycle of a half-cell employing the protective layer of Example 2. FIG. 9B shows initial charging and discharging of the half-cell employing the protective layer of Example 2. The half-cell of Example 2 exhibited safe cycle characteristics in the same manner as the half-cell of Example 1. The composite in the protective layer provided sufficient diffusion paths of lithium ions. Thereby, the proportion of the metal sulfide in the composite needs to be 5 or less, and the performance of the half-cell may be increased by adjusting the mass ratio of the metal sulfide to the carbon component.

### Example 3

A protective layer was formed in the same manner as in Example 1 except that vapor-grown carbon fiber (VGCF) was used as a carbon component.

### Example 4

A protective layer was formed in the same manner as in Example 1 except that multi-wall carbon nanotubes were used as a carbon component.

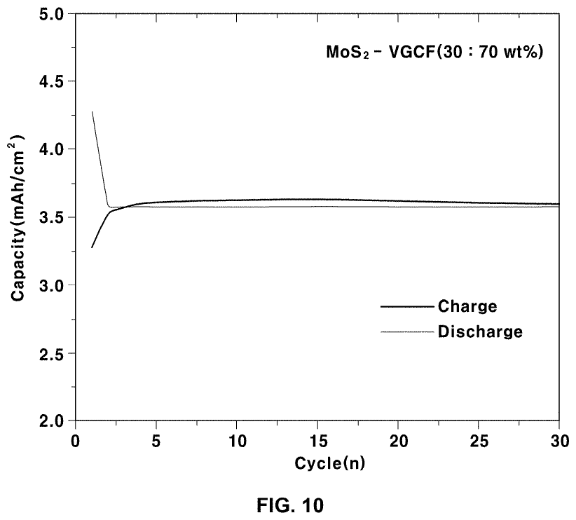

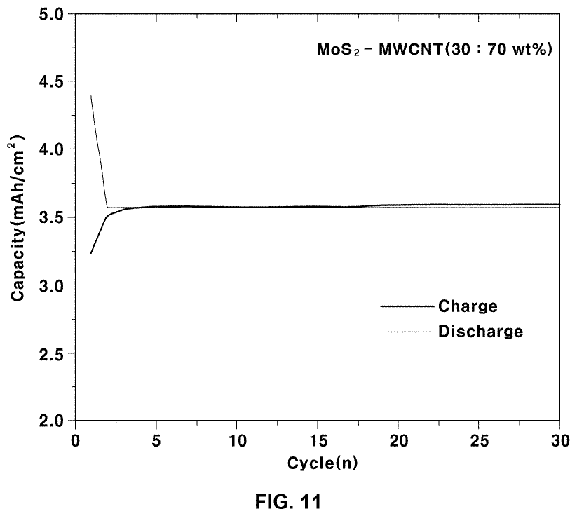

FIG. 10 shows charge and discharge cycle of a half-cell employing the protective layer of Example 3. FIG. 11 shows charge and discharge cycle of a half-cell employing the protective layer of Example 4. The current density was 1.17 mA/cm², and a deposition capacity was 3.525 mAh/cm². Thus, the half-cells employing the protective layers including the respective carbon components were stably driven.

According to various exemplary embodiments of the present invention, an all-solid-state battery which may uniformly precipitate and store lithium metal on an anode current collector can be provided.

Further, the all-solid-state battery according to the present invention may have a greatly improved energy density.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An all-solid-state battery comprising:
an anode current collector;
a protective layer disposed on the anode current collector;
a solid electrolyte layer disposed on the protective layer;
a cathode active material layer disposed on the solid electrolyte layer; and
a cathode current collector disposed on the cathode active material layer,
wherein the protective layer comprises:
a matrix comprising a composite comprising a metal sulfide and a carbon component; and
a metal component distributed in the matrix and capable of alloying with lithium.

2. The all-solid-state battery of claim 1, wherein the metal sulfide comprises a compound represented by MₓS_{y}, wherein M comprises one or more of Mo, W, Cu, Co, Ti, Ni, and Fe, 1≤x≤3 and 0.5≤y≤4.

3. The all-solid-state battery of claim 1, wherein the carbon component comprises spherical particles having a particle size D50 of about 10 nm to 100 nm, or linear particles having a cross-sectional diameter of about 10 nm to 300 nm.

4. The all-solid-state battery of claim 1, wherein the carbon component comprises one or more of carbon black, carbon nanotubes, carbon fiber, vapor-grown carbon fiber (VGCF) or any combination thereof.

5. The all-solid-state battery of claim 1, wherein a particle size D50 of the composite ranges from about 10 nm to 1 μm.

6. The all-solid-state battery of claim 1, wherein the composite comprises the metal sulfide and the carbon component at a mass ratio of about 2:8 to 5:5.

7. The all-solid-state battery of claim I, wherein the metal component comprises one or more of Ag, Zn, Mg, Bi, and Sn.

8. The all-solid-state battery of claim 1, wherein a particle size D50 of the metal component ranges from about 30 nm to 500 nm.

9. The all-solid-state battery of claim 1 wherein the protective layer comprises an amount of about 50% to 80% by weight of the matrix and an amount of about 20% to 50% by weight of the metal component, based on the total weight of the protective layer, and has a thickness of about 1 μm to 20 μm.

10. The all-solid-state battery of claim 1, wherein the metal sulfide reacts with lithium ions to produce lithium sulfide (Li₂S) and a metal during charging and discharging of the all-solid-state battery, and lithium is stored between the anode current collector and the protective layer.

11. A method for manufacturing an all-solid-state battery, comprising:
preparing a composite comprising a metal sulfide and a carbon component by performing mechanical milling;
preparing a slurry comprising the composite and a metal component capable of alloying with lithium;
forming a protective layer by applying the slurry to a substrate; and
preparing a stack comprising an anode current collector, the protective layer disposed on the anode current collector, a solid electrolyte layer disposed on the protective layer, a cathode active material layer disposed on the solid electrolyte layer, and a cathode current collector disposed on the cathode active material layer,
wherein the protective layer comprises:
a matrix comprising the composite comprising the metal sulfide and the carbon component; and
the metal component distributed in the matrix and capable of alloying with lithium.

12. The method of claim 11, wherein the metal sulfide comprises a compound represented by MₓS_{y}, wherein M comprises one or more of Mo, W, Cu, Co, Ti, Ni, and Fe, 1≤x≤3 and 0.5≤y≤4.

13. The method of claim 11, wherein a particle size D50 of the metal sulfide ranges from about 10 nm to 50 μm.

14. The method of claim 11, wherein the carbon component comprises spherical particles having a particle size D50 of about 10 nm to 100 nm, or linear particles having a cross-sectional diameter of about 10 nm to 300 nm.

15. The method of claim 11, wherein the carbon component comprises one or more of carbon black, carbon nanotubes, carbon fiber, and vapor-grown carbon fiber (VGCF).

16. The method of claim 11, wherein a particle size D50 of the composite ranges from about 10 nm to 1 μm.

17. The method of claim 11, wherein the composite comprises the metal sulfide and the carbon component at a mass ratio of about 2:8 to 5:5.

18. The method of claim 11, wherein the metal component comprises one or more of Ag, Zn, Mg, Bi, and Sn.

19. The method of claim 11, wherein a particle size D50 of the metal component ranges from about 30 nm to 500 nm.

20. The method of claim 11, wherein the protective layer comprises an amount of about 50% to 80% by weight of the matrix and an amount of about 20% to 50% by weight of the metal component, based on the total weight of the protective layer, and has a thickness of about 1 μm to 20 μm.
